(19) United States
(12) Patent Application Publication
(10) Pub. No.: US 2025/0211302 A1
(43) Pub. Date: Jun. 26, 2025

(54) ENHANCED CHANNEL STATUS INDICATOR PREDICTIONS

(71) Applicant: Intel Corporation, Santa Clara, CA (US)

(72) Inventors: Arvind MERWADAY, Beaverton, OR (US); Rath VANNITHAMBY, Portland, OR (US)

(21) Appl. No.: 18/393,775

(22) Filed: Dec. 22, 2023

(51) Int. Cl. H04B 7/06; H04B 7/0452; H04B 17/391

(52) U.S. Cl. CPC H04B 7/0626; H04B 7/0452; H04B 7/0617; H04B 17/3913

(57) ABSTRACT

Disclosed herein are devices, methods, and systems for predicting channel status information (CSI) values and their confidence levels. The system may obtain a current CSI value of a wireless channel at a current time and generate, based on the current CSI value and a learning model that is based on CSI values and CSI predictions, a predicted CSI value and a confidence metric. The system may generate a recommended periodicity of CSI measurements of the wireless channel. In addition, the confidence metric is for the predicted CSI value based on the learning model, wherein the confidence metric indicates a level of confidence in the predicted CSI value for the prediction time. The system may adjust a scheduling parameter for the wireless channel based on the predicted CSI value and the confidence metric.

### TECHNICAL FIELD

The disclosure relates generally to wireless communications, and in particular, to improved predictions of channel status indicator (CSI) values, their accuracy, and the frequency with which they should be collected.

### BACKGROUND

In wireless communication systems, such as in cellular systems and with base stations, the quality of the communications over a wireless channel is often measured and reported to the system in the form of a channel status indicator (CSI) value. In some cases, the quality of a channel may also be predicted for a future time (e.g., for +1 ms, +5 ms, +10 ms from the current time) and a predicted CSI value is then reported for the predicted future time(s). However, the coherence time of a wireless channel often depends on the speed of the communicating device (e.g., the speed of the user equipment (“UE”)) and the dynamicity of environment (e.g., the nature of fading in the environment). As a result, CSI prediction accuracy may vary significantly depending on the speed of the UE, the environment, and/or the prediction time. If the predicted CSI values are inaccurate, this might result in sub-optimal performance of those portions of the wireless protocol that may rely on the CSI values, such as the channel scheduler (e.g., the base station or g-Node-B (gNB) of a cellular system).

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of a channel status indicator (CSI) prediction system that may provide not only predicted CSI values but also an accuracy metric and a recommended periodicity for CSI reference signals;

FIG. 2 shows an exemplary flow diagram of how the learning model of a CSI prediction system may be trained, including for each of the enhanced set of CSI-related values;

FIG. 3 depicts an example implementation of a CSI prediction system on the network side, using the Open Radio Access Network (O-RAN) architecture as an example framework;

FIG. 4 depicts an example implementation of a CSI prediction system on the user equipment (UE) side;

FIG. 5 shows an exemplary schematic drawing of a device for predicting CSI values along with an accuracy metric and/or a recommended periodicity for CSI reference signals; and

FIG. 6 depicts a schematic flow diagram of an exemplary method for predicting CSI values along with an accuracy metric.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

As noted above, the quality of the communications over a wireless channel is often measured and reported to the system in the form of a channel status indicator (CSI) value that may also be predicted for a future time (e.g., for +1 ms, +5 ms, +10 ms, etc. from the current time). However, CSI prediction accuracy may vary significantly depending on the speed of user equipment (“UE”) and the nature of the environment in which the UE is located/moving, and/or the prediction time. If the predicted CSI values are inaccurate, this might result in sub-optimal performance of those portions of the wireless protocol that may rely on the CSI values, such as the channel scheduler (e.g., the base station or g-Node-B (gNB) of a cellular system). Accurate knowledge of channel conditions may be important for optimizing the performance of the communication system, as knowing accurate channel conditions may allow for better resource allocation, power control, and interference management.

To estimate channel quality, the base station or UE may make channel measurements and report a CSI value to the network. For the UE to estimate channel conditions, the network (e.g., via a base station or gNB) may transmit cell-specific CSI reference signals (CSI-RS) to the UE, and based on a comparison of the received signals to the transmitted reference signals, the UE may report a CSI value to the network. Because the transmitted reference signals are known to both the UE and the network, they may serve as a reference for the UE to estimate the current channel conditions. The UE may be instructed (e.g., by the network) to periodically receive the CSI-RS and report a CSI value. The network (e.g., the base station or gNB) may indicate in a measurement configuration message the CSI-RS resources that the UE is to monitor, the frequency and time domain resources that will be used for the CSI-RS signals, and the measurement reporting periodicity (as used herein, the interval at which the UE is instructed to measure and report channel conditions is referred to “CSI-RS periodicity,” “periodicity of CSI measurements,” “periodicity of CSI-RS measurements,” “periodicity,” etc.). Then, the UE estimates channel conditions based on the measurement configuration and reports a CSI value, according to the periodicity. Such a process is outlined in, for example, the cellular standards of the 3rd Generation Partnership Project (3GPP) and in particular the Technical Specification Group Radio Access Network, including technical specifications and technical reports such as: 3GPP TR 21.905 “Vocabulary for 3GPP Specifications;” 3GPP TR 38.802 “Study on new radio access technology Physical layer aspects;” and 3GPP TR 38.843 “Study on Artificial Intelligence (AI)/Machine Learning (ML) for NR air interface.”

The UE may also estimate a predicted CSI value for a future point(s) in time that may be based on an earlier channel estimation, predicted for the future point(s) in time. However, predicting a CSI value for a future point in time may be difficult, where the speed of the UE may be unknown (e.g., a UE's speed may be arbitrary and/or nonconstant), the environment (e.g., fading conditions) may be unknown, and other factors may be unknown at the future point in time. To this end, a learning model (e.g., a neural network) may be used to predict CSI values at future points in time based on current conditions (e.g., the current channel estimate/CSI value, the UE's movement/speed, the environment, etc.). However, conventional learning models for predicting CSI values do not provide any measure of accuracy of the predictions of CSI values and do not provide a recommendation for periodicity of CSI-RS measurements.

As discussed in more detail below, the disclosed CSI prediction system may not only generate predicted CSI values, but also may generate additional information (e.g., metadata) along with the predicted CSI value(s), including, for example, an accuracy metric (e.g., a confidence level) for the predicted CSI value and a recommendation for CSI-RS periodicity. The accuracy metric and/or the recommended CSI-RS periodicity may be used by the UE or the network to adapt its behavior (e.g., scheduling decisions, CSI reporting decisions, channel estimation decisions, etc.) to the dynamically changing conditions of the wireless channel. As should be understood, the CSI prediction may be performed by the UE and/or by the network (e.g., at the gNB scheduler). Because the disclosed CSI prediction system provides an accuracy metric along with the predicted CSI value, the network and/or the UE may be able to make scheduling decisions that are better adapted to the dynamically changing channel characteristics, may experience increased throughput due to improved beamforming and better beam management, and/or may reduce overheads of CSI-RS and channel estimation feedback transmissions.

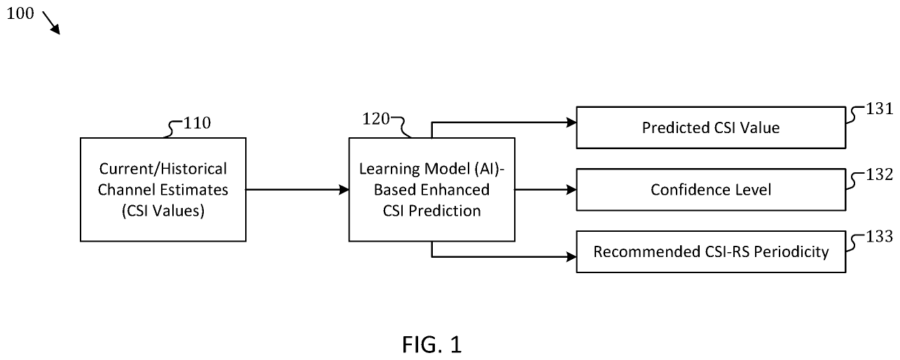

FIG. 1 shows an example of a CSI prediction system 100 that may provide not only predicted CSI values but also an accuracy metric (e.g., a confidence level) and a recommended CSI-RS periodicity (e.g., the recommended interval at which the UE should measure and report channel conditions to the scheduler). For example, CSI prediction system 100 may include a learning model 120 (e.g., an AI-based, enhanced CSI Prediction neural network) that uses current and historical channel estimates 110 (e.g., current/historical CSI values) to determine a predicted CSI value 131 for a future point in time. The learning model 120 may also determine, associated with the predicted CSI value 131, a confidence level 132 that indicates a degree of accuracy of the predicted CSI value 131. In addition, the learning model 120 may determine a recommended CSI-RS periodicity 133 that indicates how often reference signals should be transmitted to the UE for estimating channel conditions based on the transmitted reference signals.

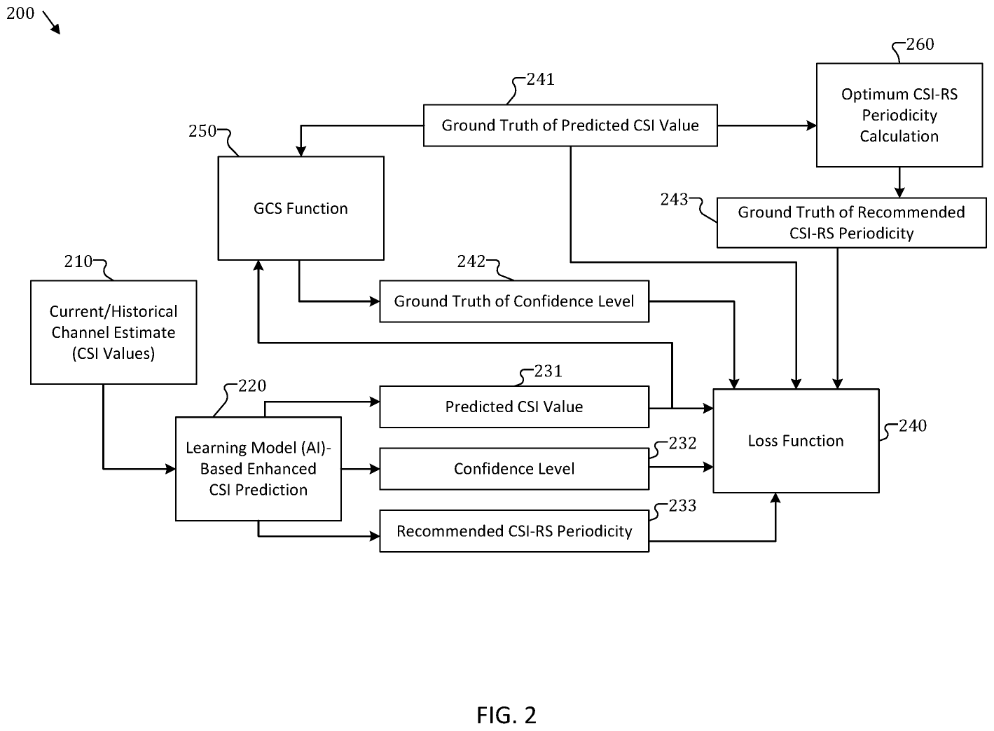

FIG. 2 shows an example of how the learning model of a CSI prediction system 200 may be trained, including each of the outputs. For example, the learning model 220 (e.g., an AI-based, enhanced CSI Prediction neural network) may use current and historical channel estimates 210 to determine a predicted CSI value 231 for a future point in time, a confidence level 232 indicating the accuracy of the predicted CSI value 231, and/or a recommended CSI-RS periodicity 233. The learning model 220 may include certain layers with memory to handle current and historical channel estimates 210 in terms of sequential or time-series data input, such as a long-term-short-term memory (LSTM), a recurrent neural network (RNN), an attention mechanism that may dynamically assign different weights to different parts of the input sequence, etc., which make it possible for the learning model 220 to keep track of the historical CSI values that were previously input into the learning model 220. The outputs (e.g., predicted CSI value 231, confidence level 232, and/or recommended CSI-RS periodicity 233) may be fed into a loss function 240 that compares the predicted CSI value 231, confidence level 232, and recommended CSI-RS periodicity 233 to their corresponding ground truth values. During training, loss function 240 may allow for back propagation to calculate gradients.

For example, the ground truth of the predicted CSI value 241 may be known at the future point time when an actual channel estimation may be made and then the as-predicted CSI value for that time may be compared to the actual CSI value. Ground truth of the confidence level 242 and ground truth of the recommended CSI-RS periodicity 243 may be determined using a function that may be based on the ground truth of the predicted CSI value 241 (e.g., calculated in real-time during the training). For example, a generalized cosine similarity (GCS) function 250 may be used to generate the ground truth of the confidence level 242 from the ground truth of the predicted CSI value 241 and its predicted CSI value 231. The GCS function 250 may output a normalized value of 1.0, for example, if the predicted CSI value 231 is the same as (or sufficiently close to) the ground truth of the predicted CSI value 241. The further away the predicted CSI value 231 is from the ground truth of the predicted CSI value 241, the GCS function 250 may output a value lower than 1.0 (e.g., approaching 0.0 for a prediction that is very far from ground truth). As should be understood, while a GCS function 250 is used an example, any type of function may be used to produce an output value (e.g., a normalized output that is between 0.0 and 1.0) that is based on the closeness of the two input vectors: ground truth of the predicted CSI value 241 and its predicted CSI value 231.

The ground truth of the recommended CSI-RS periodicity 243 may be determined in advance based on the availability of the ground truth of the predicted CSI value 241, or it may be determined in real-time during the training. Any number of algorithms for calculating the optimum CSI-RS periodicity 260 to use as the ground truth of the recommended CSI-RS periodicity 243. For example, as shown in FIG. 2, the ground truth of the predicted CSI value 241 may be used to estimate a maximum doppler frequency. Based on the maximum doppler frequency, the algorithm may calculate a coherence time of the channel. Then, the algorithm may calculate the optimum CSI-RS periodicity 260 as a function of channel coherence time.

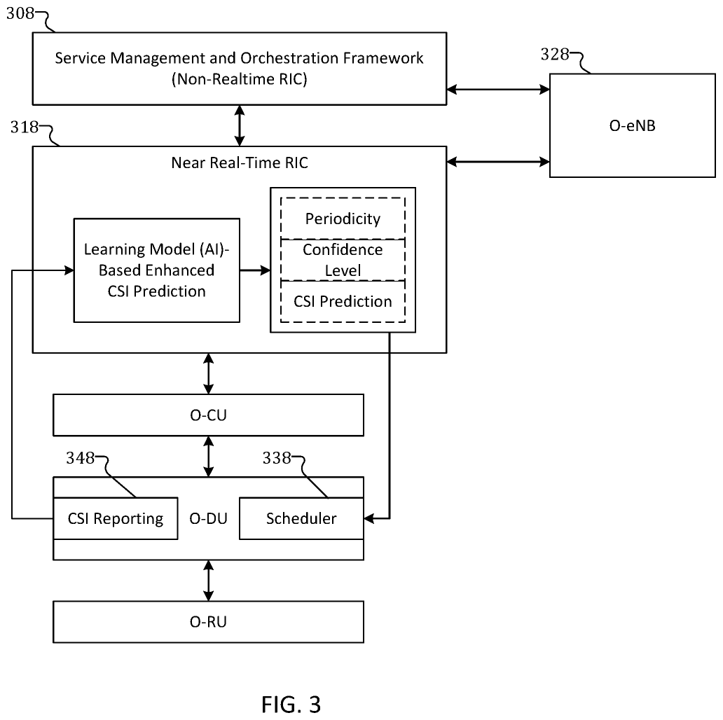

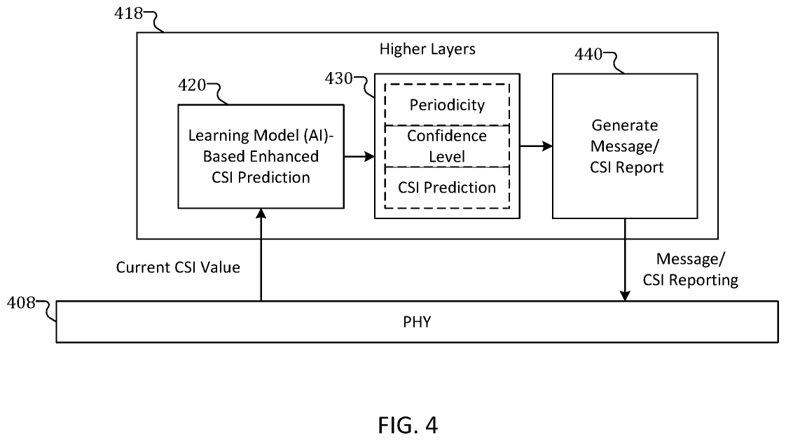

The CSI prediction system (e.g., CSI prediction system 100) may be implemented on either the network side (e.g., on the gNB) or at the end-user device (e.g., the UE), examples of which are shown in FIGS. 3 and 4, respectively. FIG. 3 shows an example implementation on the network side, using the Open Radio Access Network (O-RAN) architecture as an example. For example, the CSI prediction system may reside in the near-real-time radio access network intelligent controller (RIC) layer 318 (e.g., in an xAPP), where the learning model (e.g., learning model 120, 220 discussed above) receives channel estimates (e.g., CSI reports) (e.g., from multiple UEs) from a reporting interface 348 of the Open Distributed Unit (O-DU). The learning model may then use these CSI reports (current and historical) to generate an enhanced set of CSI prediction data, including predicted CSI values, an associated confidence level, and recommended periodicity. This enhanced set of CSI prediction data may be provided, for example, to the network scheduler 338 that may also be part of the O-DU.

The network scheduler 338 may then use this information to make intelligent scheduling decisions (e.g., for multiple UEs), optimize key performance indicators, and satisfy other (e.g., required) parameters. For example, for UEs that have high confidence levels associated with their CSI value predictions, the network scheduler 338 may set the scheduling parameters which are sensitive to channel aging, such as multi-user MIMO (MU-MIMO) precoding, optimistically (e.g., narrow beams), while for UE's that have lower confidence levels in their associated CSI value predictions, the network scheduler 338 may set the channel-aging-sensitive scheduling parameters conservatively (e.g., wider beams).

As another example, if the confidence level of CSI value predictions for given a UE meet a predetermined criterion (e.g., the confidence level is consistently below a minimum threshold for certain period), then the gNB may determine to replace the learning model with a different model (e.g. with a learning model that is trained/designed for a different UE speed or a different fading profile). As another example, the network scheduler 338 may adjust the periodicity of downlink CSI-RS transmissions based on the recommended periodicity provided by the enhanced CSI prediction system. By adjusting the periodicity, the overhead caused by transmission of CSI-RS to UEs and return transmissions of the corresponding channel estimates may be optimized (e.g., minimized) based on the specifics of each UE. For example, the network scheduler 338 may increase the frequency of CSI-RS transmissions for high speed UEs (which will likely have a higher recommended periodicity) while decreasing the frequency of CSI-RS transmission for low speed UEs (which will likely have a lower recommended periodicity).

FIG. 4 shows an example implementation on the UE side, where the CSI prediction system (e.g., CSI prediction system 100) may be executed in the higher layers of the UE. The UE may make channel estimates at the physical layer (PHY) and use this information to predict CSI values where the learning model 420 (e.g., learning model 120, 220 discussed above) receives the channel estimates (e.g., CSI values). The learning model 420 may then use these CSI values (current and historical) to generate an enhanced set of CSI prediction data 430, including predicted CSI values, an associated confidence level, and/or recommended periodicity. The UE may use this enhanced set of CSI prediction data 430 to generate, in 440, a message or CSI report based on the enhanced set of CSI prediction data 430. For example, if the confidence level satisfies a predefined criterion (e.g., is higher than a predefined minimum confidence threshold), the UE may report the predicted CSI values to the network (e.g., in the CSI report transmitted to the base station), whereas if the confidence level is low (e.g., is lower than a predefined minimum confidence threshold), the UE may report the measured CSI values to the network.

As another example, the UE may keep track of the recommended CSI-RS periodicity output, and if there is a difference between the current periodicity and the recommend periodicity, the UE may send a request to the network schedule for changing the periodicity (e.g., an RRC reconfiguration request). As another example, the UE may keep track of the confidence level over a certain period of time, and if it satisfies a predefined criterion (e.g., it stays consistently too low), then the UE may send a request to the network to provide an updated learning model (e.g., a new neural network model) in hopes of finding a better predictor of channel performance for the current conditions (e.g., a learning model that has been tuned for a different speed of the UE, with different fading provides, or under different channel conditions). As should be appreciated, these are merely exemplary ways in which the UE may utilize the enhanced set of CSI prediction data 430, and the UE may make other types of decisions, generate other types of reports, or transmit other requests based on the enhanced set of CSI prediction data 430.

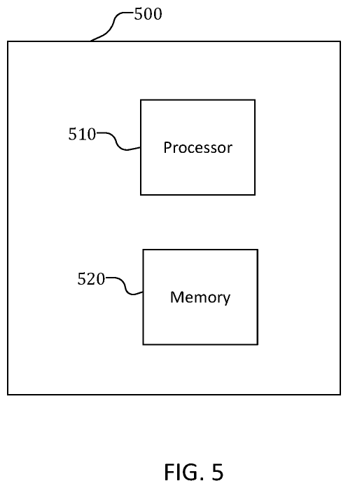

FIG. 5 is a schematic drawing illustrating a device 500 for determining an enhanced set of CSI prediction data and adjusting scheduling parameters accordingly. Device 500 may include any of the features described above with respect to the enhanced set of CSI prediction data, including predicted CSI values, associated confidence levels, and recommended periodicities. The device 500 of FIG. 5 may be implemented as a device, a method, and/or a computer readable medium that, when executed, performs the enhanced set of CSI prediction data features described above. It should be understood that device 500 is only an example, and other configurations may be possible that include, for example, different components or additional components.

Device 500 includes a processor 510 connected to a memory 520. In addition to or in combination with any of the features described in the following paragraphs, processor 510 is configured to obtain a current channel status information (CSI) value of a wireless channel at a current time. In addition to or in combination with any of the features described in the following paragraphs, processor 510 is also configured to generate, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. In addition to or in combination with any of the features described in the following paragraphs, processor 510 is configured to adjust a scheduling parameter for the wireless channel based on the predicted CSI value and the confidence metric.

Furthermore, in addition to or in combination with any of the features described in this or the preceding paragraph with respect to device 500, processor 510 may be further configured to generate, based on the current CSI value and the learning model, a recommended periodicity of CSI measurements of the wireless channel. Furthermore, in addition to or in combination with any of the features described in this or the preceding paragraph, the recommended periodicity of CSI measurements may be further based on a channel coherence time for the wireless channel. Furthermore, in addition to or in combination with any of the features described in this or the preceding paragraph, processor 510 may be further configured to adjust a frequency of transmission of CSI reference signals (CSI-RS) over the wireless channel based on the periodicity. Furthermore, in addition to or in combination with any of the features described in this or the preceding paragraph, the scheduling parameter may include a beam width for wireless transmissions (e.g., over the wireless channel). Furthermore, in addition to or in combination with any of the features described in this or the preceding paragraph, when the confidence metric is high, the scheduling parameter may include a narrow beam width and when the confidence metric is low, the scheduling parameter may include a wide beam width.

Furthermore, in addition to or in combination with any of the features described in this or the preceding two paragraphs with respect to device 500, processor may be configured to generate a series of predicted CSI values, each at a corresponding prediction time that is different from (e.g., ahead of) the current time and each associated with a corresponding confidence metric, wherein the predicted CSI value and the confidence metric may be one of the series of predicted CSI values and its corresponding confidence metric. Furthermore, in addition to or in combination with any of the features described in this or the preceding two paragraphs, wherein when the series of predicted CSI values and their corresponding confidence metrics satisfies a predefined criterion, processor 510 may be further configured to replace the learning model with a revised learning model that has been trained on a different type of mobility of a user equipment, on different channel characteristics, and/or on a different fading profile. Furthermore, in addition to or in combination with any of the features described in this or the preceding two paragraphs, the different type of mobility of the user equipment may include a different movement speed of the user equipment and/or different environmental characteristics.

Furthermore, in addition to or in combination with any of the features described in this or the preceding three paragraphs with respect to device 500, the different fading profile may include one of a static profile, a PB3 profile, a PA3 profile, a VA3 profile, a VA30 profile, a VA120 profile, an EPA5 profile, an EVA5 profile, an EVA70 profile, an ETU70 profile, an ETU300 profile, and an HST profile. Furthermore, in addition to or in combination with any of the features described in this or the preceding two paragraphs, the predefined criterion may be satisfied when at least one of the corresponding confidence metrics falls below a threshold value. Furthermore, in addition to or in combination with any of the features described in this or the preceding three paragraphs, the predefined criterion may be satisfied when a predefined number of the corresponding confidence metrics falls below a threshold value. Furthermore, in addition to or in combination with any of the features described in this or the preceding three paragraphs, the predefined criterion may be satisfied when a predefined number of consecutive ones of the corresponding confidence metrics falls below a threshold value.

Furthermore, in addition to or in combination with any of the features described in this or the preceding four paragraphs with respect to device 500, the learning model may further relate a movement speed of a user equipment to the CSI predictions. Furthermore, in addition to or in combination with any of the features described in this or the preceding four paragraphs, the scheduling parameter may include a multi-user multiple in multiple out (MU-MIMO) precoding, wherein if the confidence metric is above a predefined upper threshold, the MU-MIMO precoding may be set for a narrow beam and if the confidence metric is below a predefined lower threshold, the MU-MIMO precoding may be set for a narrow beam. Furthermore, in addition to or in combination with any of the features described in this or the preceding four paragraphs, the predefined upper threshold may be different from the predefined lower threshold. Furthermore, in addition to or in combination with any of the features described in this or the preceding four paragraphs, the predicted CSI value and/or the confidence metric may be further based on a rate of change of a channel coefficient in a time domain.

Furthermore, in addition to or in combination with any of the features described in this or the preceding five paragraphs with respect to device 500, processor 510 may be further configured to generate, based on the current CSI value and the learning model, a recommended periodicity of CSI measurements of the wireless channel. Furthermore, in addition to or in combination with any of the features described in this or the preceding four paragraphs, memory 520 may be configured to store the current CSI value, the learning model, the predicted CSI value, the confidence metric, and/or the scheduling parameter.

Alternatively, device 500 may be for a user equipment, wherein device 500 includes processor 510 connected to memory 520. In addition to or in combination with any of the features described in the following paragraphs, processor 510 is configured to measure a current channel status information (CSI) value of a wireless channel at a current time and generate, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. In addition to or in combination with any of the features described in the following paragraphs, processor 510 is also configured to generate a resource report for sending to a base station, wherein the resource report is based on the predicted CSI value and the confidence metric.

Furthermore, in addition to or in combination with any of the features described in this or the preceding paragraph with respect to device 500, the resource report may include a measurement report comprising a reported CSI value that is either the predicted CSI value or the current CSI value, depending on whether the confidence metric satisfies a predefined criterion. Furthermore, in addition to or in combination with any of the features described in this or the preceding paragraph, the predefined criterion may include that when the confidence level is higher than a predefined threshold, the reported CSI value is the predicted CSI value and when the confidence level is at or below the predefined threshold, the reported CSI value is the current CSI value. Furthermore, in addition to or in combination with any of the features described in this or the preceding paragraph, processor 510 may be further configured to generate, based on the current CSI value and the learning model, a recommended periodicity of CSI measurements of the wireless channel. Furthermore, in addition to or in combination with any of the features described in this or the preceding paragraph, the resource report may include a resource change request (e.g., an RRC reconfiguration request) to change a frequency of transmission of CSI reference signals (CSI-RS) to the recommended periodicity.

Furthermore, in addition to or in combination with any of the features described in this or the preceding two paragraphs with respect to device 500, the resource report may include a learning model update request (e.g., an updated NN model) to transmit a revised learning model to replace the learning model, wherein the revised learning model has been trained on a different type of mobility, on a different fading profile, or on other channel statistics.

Alternatively, device 500 may be a device for training a learning model that relates channel status information (CSI) values to CSI predictions, confidence levels of the CSI predictions, and/or recommended CSI-reference signal (RS) periodicities. Device 500 may include a processor 510 connected to memory 520 where the processor 510 is configured to obtain a current CSI value that is associated with a ground truth of a predicted CSI value. In addition to or in combination with any of the features described in the following paragraphs, processor 510 may also determine a predicted CSI value, a confidence level of the predicted CSI value, and/or to a recommended CSI-RS periodicity, each based on the learning model at the current CSI value. In addition to or in combination with any of the features described in the following paragraphs, processor 510 may be configured to compute a loss function that compares the predicted CSI value to the ground truth of the predicted CSI value. In addition to or in combination with any of the features described in the following paragraphs, processor 510 may be configured to update the learning model based on the loss function.

Furthermore, in addition to or in combination with any of the features described in this or the preceding paragraph with respect to device 500, the loss function may also compare the confidence level of the predicted CSI value to a ground truth of the confidence level. Furthermore, in addition to or in combination with any of the features described in this or the preceding paragraph, the ground truth of the confidence level may be based on a function that outputs a factor indicating the closeness of the predicted CSI value to the ground truth of the predicted CSI value. Furthermore, in addition to or in combination with any of the features described in this or the preceding paragraph, the function may be a generalized cosine similarity (GCS) function, wherein the factor is between zero and one.

Furthermore, in addition to or in combination with any of the features described in this or the preceding two paragraphs with respect to device 500, the loss function may also compare the recommended CSI-RS periodicity to a ground truth of the recommended CSI-RS periodicity. Furthermore, in addition to or in combination with any of the features described in this or the preceding two paragraphs, the ground truth of the recommended CSI-RS periodicity may be an optimum CSI-RS periodicity that is a function of channel coherence time, wherein the channel coherence time may be based on an estimated maximum doppler frequency associated with the ground truth of the predicted CSI value.

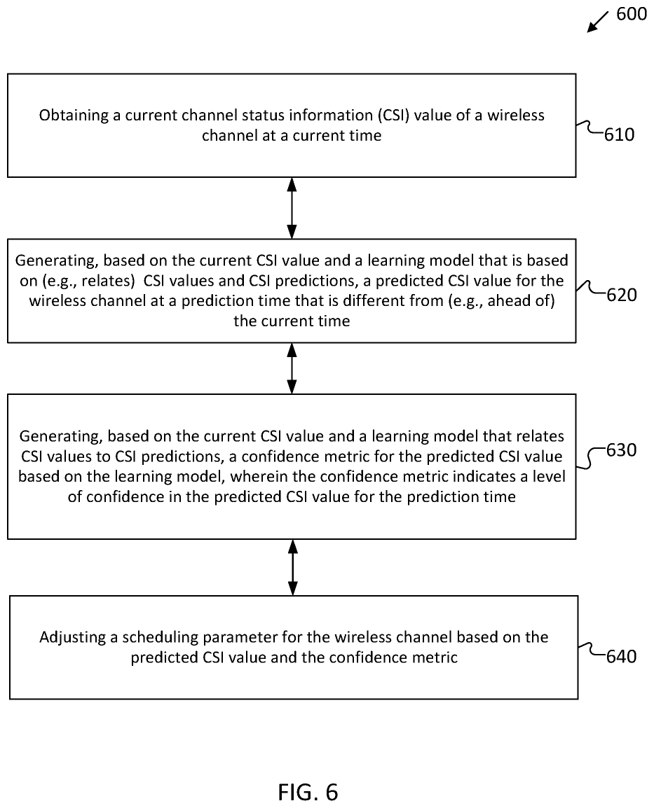

FIG. 6 depicts a schematic flow diagram of a method 600 for determining an enhanced set of CSI prediction data and adjusting scheduling parameters accordingly. Method 600 may implement any of the features of the enhanced set of CSI prediction data described above.

Method 600 includes, in 610, obtaining a current channel status information (CSI) value of a wireless channel at a current time. Method 600 also includes, in 620, generating, based on the current CSI value and a learning model that is based on (e.g., relates) CSI values and CSI predictions, a predicted CSI value for the wireless channel at a prediction time that is different from (e.g., ahead of) the current time. Method 600 also includes, in 630, generating, based on the current CSI value and a learning model that is based on (e.g., relates) CSI values and CSI predictions, a confidence metric for the predicted CSI value based on the learning model, wherein the confidence metric indicates a level of confidence in the predicted CSI value for the prediction time. Method 600 also includes, in 640, adjusting a scheduling parameter for the wireless channel based on the predicted CSI value and the confidence metric.

In the following, various examples are provided that may include one or more features of the enhanced set of CSI prediction data discussed above. It may be intended that aspects described in relation to the devices may apply also to the described method(s), and vice versa.

Example 1 is a device including a processor configured to obtain a current channel status information (CSI) value of a wireless channel at a current time. The processor is also configured to generate, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. The processor is also configured to adjust a scheduling parameter for the wireless channel based on the predicted CSI value and the confidence metric.

Example 2 is the device of example 1, wherein the processor is further configured to generate, based on the current CSI value and the learning model, a recommended periodicity of CSI measurements of the wireless channel.

Example 3 is the device of example 2, wherein the recommended periodicity of CSI measurements is further based on a channel coherence time for the wireless channel.

Example 4 is the device of any one of examples 2 to 3, wherein the processor is further configured to adjust a frequency of transmission of CSI reference signals (CSI-RS) over the wireless channel based on the periodicity.

Example 5 is the device of any one of examples 1 to 4, wherein the scheduling parameter includes a beam width for wireless transmissions over the wireless channel.

Example 6 is the device of any one of examples 1 to 5, wherein when the confidence metric is high, the scheduling parameter includes a narrow beam width and when the confidence metric is low the scheduling parameter includes a wide beam width.

Example 7 is the device of any one of examples 1 to 6, wherein the processor is configured to generate a series of predicted CSI values, each at a corresponding prediction time that is different from (e.g., ahead of) the current time and each associated with a corresponding confidence metric, wherein the predicted CSI value and the confidence metric are one of the series of predicted CSI values and its corresponding confidence metric.

Example 8 is the device of example 7, wherein when the series of predicted CSI values and their corresponding confidence metrics satisfies a predefined criterion, the processor is further configured to replace the learning model with a revised learning model that has been trained on a different type of mobility of a user equipment, on different channel characteristics, and/or on a different fading profile.

Example 9 is the device of example 8, wherein the different type of mobility of the user equipment includes a different movement speed of the user equipment and/or different environmental characteristics.

Example 10 is the device of example 8, wherein the different fading profile includes one of a static profile, a PB3 profile, a PA3 profile, a VA3 profile, a VA30 profile, a VA120 profile, an EPA5 profile, an EVA5 profile, an EVA70 profile, an ETU70 profile, an ETU300 profile, and an HST profile.

Example 11 is the device of any one of examples 8 to 10, wherein the predefined criterion is satisfied when at least one of the corresponding confidence metrics falls below a threshold value.

Example 12 is the device of any one of examples 8 to 11, wherein the predefined criterion is satisfied when a predefined number of the corresponding confidence metrics falls below a threshold value.

Example 13 is the device of any one of examples 8 to 12, wherein the predefined criterion is satisfied when a predefined number of consecutive ones of the corresponding confidence metrics falls below a threshold value.

Example 14 is the device of any one of examples 1 to 13, wherein the learning model further relates a movement speed of a user equipment to the CSI predictions.

Example 15 is the device of any one of examples 1 to 14, wherein the scheduling parameter includes a multi-user multiple in multiple out (MU-MIMO) precoding, wherein if the confidence metric is above a predefined upper threshold, the MU-MIMO precoding is set for a narrow beam and if the confidence metric is below a predefined lower threshold, the MU-MIMO precoding is set for a narrow beam.

Example 16 is the device of example 15, wherein the predefined upper threshold is different from the predefined lower threshold.

Example 17 is the device of any one of examples 1 to 16, wherein the predicted CSI value and/or the confidence metric is further based on a rate of change of a channel coefficient in a time domain.

Example 18 is the device of either one of examples 2 or 3, wherein the processor is further configured to generate, based on the current CSI value and the learning model, a recommended periodicity of CSI measurements of the wireless channel.

Example 19 is the device of any one of examples 1 to 18, the device further including a memory configured to store the current CSI value, the learning model, the predicted CSI value, the confidence metric, and/or the scheduling parameter.

Example 20 is a user equipment including a processor configured to measure a current channel status information (CSI) value of a wireless channel at a current time. The processor is further configured to generate, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. The processor is further configured to generate a resource report for sending to a base station, wherein the resource report is based on the predicted CSI value and the confidence metric.

Example 21 is the user equipment of example 21, wherein the resource report includes a measurement report including a reported CSI value that is either the predicted CSI value or the current CSI value, depending on whether the confidence metric satisfies a predefined criterion.

Example 22 is the user equipment of example 21, wherein the predefined criterion includes that when the confidence level is higher than a predefined threshold, the reported CSI value is the predicted CSI value and when the confidence level is at or below the predefined threshold, the reported CSI value is the current CSI value.

Example 23 is the user equipment of any one of examples 20 to 22, wherein the processor is further configured to generate, based on the current CSI value and the learning model, a recommended periodicity of CSI measurements of the wireless channel.

Example 24 is the user equipment of example 23, wherein the resource report includes a resource change request (e.g., an RRC reconfiguration request) to change a frequency of transmission of CSI reference signals (CSI-RS) to the recommended periodicity.

Example 25 is the user equipment of any one of examples 20 to 24, wherein the resource report includes a learning model update request (e.g., an updated NN model) to transmit a revised learning model to replace the learning model, wherein the revised learning model that has been trained on a different type of mobility, on a different fading profile, or on other channel statistics.

Example 26 is a device for training a learning model that relates channel status information (CSI) values to: CSI predictions; confidence levels of the CSI predictions; and/or recommended CSI-reference signal (RS) periodicities, the device including a processor configured to obtain a current CSI value that is associated with a ground truth of a predicted CSI value. The processor is further configured to determine a predicted CSI value, a confidence level of the predicted CSI value, and/or to a recommended CSI-RS periodicity, each based on the learning model at the current CSI value. The processor is further configured to compute a loss function that compares the predicted CSI value to the ground truth of the predicted CSI value. The processor is further configured to update the learning model based on the loss function.

Example 27 is the device of example 26, wherein the loss function is configured to compare the confidence level of the predicted CSI value to a ground truth of the confidence level.

Example 28 is the device of example 27, wherein the processor is configured to determine the ground truth of the confidence level based on a function that outputs a factor indicating the closeness of the predicted CSI value to the ground truth of the predicted CSI value.

Example 29 is the device of example 28, wherein the function is a generalized cosine similarity (GCS) function, wherein the factor is between zero and one.

Example 30 is the device of any one of examples 26 to 29, wherein the loss function is configured to compare the recommended CSI-RS periodicity to a ground truth of the recommended CSI-RS periodicity.

Example 31 is the device of example 30, wherein the processor is configured to determine the ground truth of the recommended CSI-RS periodicity based on an optimum CSI-RS periodicity that is a function of channel coherence time, wherein the channel coherence time is based on an estimated maximum doppler frequency associated with the ground truth of the predicted CSI value.

Example 32 is a non-transitory, computer-readable medium including instructions that, when executed, cause one or more processors to obtain a current channel status information (CSI) value of a wireless channel at a current time. The instructions also cause the one or more processors to generate, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. The instructions also cause the one or more processors to adjust a scheduling parameter for the wireless channel based on the predicted CSI value and the confidence metric.

Example 33 is the non-transitory, computer-readable medium of example 32, wherein the instructions further cause the one or more processors to generate, based on the current CSI value and the learning model, a recommended periodicity of CSI measurements of the wireless channel.

Example 34 is the non-transitory, computer-readable medium of example 33, wherein the recommended periodicity of CSI measurements is further based on a channel coherence time for the wireless channel.

Example 35 is the non-transitory, computer-readable medium of any one of examples 33 to 34, wherein the instructions further cause the one or more processors to adjust a frequency of transmission of CSI reference signals (CSI-RS) over the wireless channel based on the periodicity.

Example 36 is the non-transitory, computer-readable medium of any one of examples 32 to 35, wherein the scheduling parameter includes a beam width for wireless transmissions over the wireless channel.

Example 37 is the non-transitory, computer-readable medium of any one of examples 32 to 36, wherein when the confidence metric is high, the scheduling parameter includes a narrow beam width and when the confidence metric is low the scheduling parameter includes a wide beam width.

Example 38 is the non-transitory, computer-readable medium of any one of examples 32 to 37, wherein the instructions further cause the one or more processors to generate a series of predicted CSI values, each at a corresponding prediction time that is different from (e.g., ahead of) the current time and each associated with a corresponding confidence metric, wherein the predicted CSI value and the confidence metric are one of the series of predicted CSI values and its corresponding confidence metric.

Example 39 is the non-transitory, computer-readable medium of example 38, wherein when the series of predicted CSI values and their corresponding confidence metrics satisfies a predefined criterion, the instructions further cause the one or more processors to replace the learning model with a revised learning model that has been trained on a different type of mobility of a user equipment, on different channel characteristics, and/or on a different fading profile.

Example 40 is the non-transitory, computer-readable medium of example 39, wherein the different type of mobility of the user equipment includes a different movement speed of the user equipment and/or different environmental characteristics.

Example 41 is the non-transitory, computer-readable medium of example 39, wherein the different fading profile includes one of a static profile, a PB3 profile, a PA3 profile, a VA3 profile, a VA30 profile, a VA120 profile, an EPA5 profile, an EVA5 profile, an EVA70 profile, an ETU70 profile, an ETU300 profile, and an HST profile.

Example 42 is the non-transitory, computer-readable medium of any one of examples 39 to 41, wherein the predefined criterion is satisfied when at least one of the corresponding confidence metrics falls below a threshold value.

Example 43 is the non-transitory, computer-readable medium of any one of examples 39 to 42, wherein the predefined criterion is satisfied when a predefined number of the corresponding confidence metrics falls below a threshold value.

Example 44 is the non-transitory, computer-readable medium of any one of examples 39 to 43, wherein the predefined criterion is satisfied when a predefined number of consecutive ones of the corresponding confidence metrics falls below a threshold value.

Example 45 is the non-transitory, computer-readable medium of any one of examples 32 to 44, wherein the learning model further relates a movement speed of a user equipment to the CSI predictions.

Example 46 is the non-transitory, computer-readable medium of any one of examples 32 to 45, wherein the scheduling parameter includes a multi-user multiple in multiple out (MU-MIMO) precoding, wherein if the confidence metric is above a predefined upper threshold, the MU-MIMO precoding is set for a narrow beam and if the confidence metric is below a predefined lower threshold, the MU-MIMO precoding is set for a narrow beam.

Example 47 is the non-transitory, computer-readable medium of example 46, wherein the predefined upper threshold is different from the predefined lower threshold.

Example 48 is the non-transitory, computer-readable medium of any one of examples 32 to 47, wherein the predicted CSI value and/or the confidence metric is further based on a rate of change of a channel coefficient in a time domain.

Example 49 is the non-transitory, computer-readable medium of either one of examples 33 or 34, wherein the instructions further cause the one or more processors to generate, based on the current CSI value and the learning model, a recommended periodicity of CSI measurements of the wireless channel.

Example 50 is the non-transitory, computer-readable medium of any one of examples 32 to 49, wherein the instructions further cause the one or more processors to store (e.g., in a memory) the current CSI value, the learning model, the predicted CSI value, the confidence metric, and/or the scheduling parameter.

Example 51 is a non-transitory, computer-readable medium comprising instructions that, when executed, cause one or more processors to measure a current channel status information (CSI) value of a wireless channel at a current time. The instructions further cause the one or more processors to generate, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. The instructions further cause the one or more processors to generate a resource report for sending to a base station, wherein the resource report is based on the predicted CSI value and the confidence metric.

Example 52 is the non-transitory, computer-readable medium of example 52, wherein the resource report includes a measurement report including a reported CSI value that is either the predicted CSI value or the current CSI value, depending on whether the confidence metric satisfies a predefined criterion.

Example 53 is the non-transitory, computer-readable medium of example 52, wherein the predefined criterion includes that when the confidence level is higher than a predefined threshold, the reported CSI value is the predicted CSI value and when the confidence level is at or below the predefined threshold, the reported CSI value is the current CSI value.

Example 54 is the non-transitory, computer-readable medium of any one of examples 51 to 53, wherein the instructions further cause the one or more processors to generate, based on the current CSI value and the learning model, a recommended periodicity of CSI measurements of the wireless channel.

Example 55 is the non-transitory, computer-readable medium of example 54, wherein the resource report includes a resource change request (e.g., an RRC reconfiguration request) to change a frequency of transmission of CSI reference signals (CSI-RS) to the recommended periodicity.

Example 56 is the non-transitory, computer-readable medium of any one of examples 51 to 55, wherein the resource report includes a learning model update request (e.g., an updated NN model) to transmit a revised learning model to replace the learning model, wherein the revised learning model that has been trained on a different type of mobility, on a different fading profile, or on other channel statistics.

Example 57 is a non-transitory, computer-readable medium for training a learning model that relates channel status information (CSI) values to: CSI predictions; confidence levels of the CSI predictions; and/or recommended CSI-reference signal (RS) periodicities, the non-transitory, computer-readable medium comprising instructions which, when executed, cause one or more processors to obtain a current CSI value that is associated with a ground truth of a predicted CSI value. The instructions further cause the one or more processors to determine a predicted CSI value, a confidence level of the predicted CSI value, and/or to a recommended CSI-RS periodicity, each based on the learning model at the current CSI value. The instructions further cause the one or more processors to compute a loss function that compares the predicted CSI value to the ground truth of the predicted CSI value. The instructions further cause the one or more processors to update the learning model based on the loss function.

Example 58 is the non-transitory, computer-readable medium of example 57, wherein the loss function is configured to compare the confidence level of the predicted CSI value to a ground truth of the confidence level.

Example 59 is the non-transitory, computer-readable medium of example 58, wherein the instructions further cause the one or more processors to determine the ground truth of the confidence level based on a function that outputs a factor indicating the closeness of the predicted CSI value to the ground truth of the predicted CSI value.

Example 60 is the non-transitory, computer-readable medium of example 59, wherein the function is a generalized cosine similarity (GCS) function, wherein the factor is between zero and one.

Example 61 is the non-transitory, computer-readable medium of any one of examples 57 to 60, wherein the loss function is configured to compare the recommended CSI-RS periodicity to a ground truth of the recommended CSI-RS periodicity.

Example 62 is the non-transitory, computer-readable medium of example 61, wherein the instructions further cause the one or more processors to determine the ground truth of the recommended CSI-RS periodicity based on an optimum CSI-RS periodicity that is a function of channel coherence time, wherein the channel coherence time is based on an estimated maximum doppler frequency associated with the ground truth of the predicted CSI value.

Example 63 is a method that includes obtaining a current channel status information (CSI) value of a wireless channel at a current time. The method also includes generating, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. The method also includes adjusting a scheduling parameter for the wireless channel based on the predicted CSI value and the confidence metric.

Example 64 is the method of example 63, wherein the method further includes generating, based on the current CSI value and the learning model, a recommended periodicity of CSI measurements of the wireless channel.

Example 65 is the method of example 64, wherein the recommended periodicity of CSI measurements is further based on a channel coherence time for the wireless channel.

Example 66 is the method of any one of examples 64 to 65, wherein the method further includes adjusting a frequency of transmission of CSI reference signals (CSI-RS) over the wireless channel based on the periodicity.

Example 67 is the method of any one of examples 63 to 66, wherein the scheduling parameter includes a beam width for wireless transmissions over the wireless channel.

Example 68 is the method of any one of examples 63 to 67, wherein when the confidence metric is high, the scheduling parameter includes a narrow beam width and when the confidence metric is low the scheduling parameter includes a wide beam width.

Example 69 is the method of any one of examples 63 to 68, wherein the method includes generating a series of predicted CSI values, each at a corresponding prediction time that is different from (e.g., ahead of) the current time and each associated with a corresponding confidence metric, wherein the predicted CSI value and the confidence metric are one of the series of predicted CSI values and its corresponding confidence metric.

Example 70 is the method of example 69, wherein when the series of predicted CSI values and their corresponding confidence metrics satisfies a predefined criterion, the method further includes replacing the learning model with a revised learning model that has been trained on a different type of mobility of a user equipment, on different channel characteristics, and/or on a different fading profile.

Example 71 is the method of example 70, wherein the different type of mobility of the user equipment includes a different movement speed of the user equipment and/or different environmental characteristics.

Example 72 is the method of example 70, wherein the different fading profile includes one of a static profile, a PB3 profile, a PA3 profile, a VA3 profile, a VA30 profile, a VA120 profile, an EPA5 profile, an EVA5 profile, an EVA70 profile, an ETU70 profile, an ETU300 profile, and an HST profile.

Example 73 is the method of any one of examples 70 to 72, wherein the predefined criterion is satisfied when at least one of the corresponding confidence metrics falls below a threshold value.

Example 74 is the method of any one of examples 70 to 73, wherein the predefined criterion is satisfied when a predefined number of the corresponding confidence metrics falls below a threshold value.

Example 75 is the method of any one of examples 70 to 74, wherein the predefined criterion is satisfied when a predefined number of consecutive ones of the corresponding confidence metrics falls below a threshold value.

Example 76 is the method of any one of examples 63 to 75, wherein the learning model further relates a movement speed of a user equipment to the CSI predictions.

Example 77 is the method of any one of examples 63 to 76, wherein the scheduling parameter includes a multi-user multiple in multiple out (MU-MIMO) precoding, wherein if the confidence metric is above a predefined upper threshold, the MU-MIMO precoding is set for a narrow beam and if the confidence metric is below a predefined lower threshold, the MU-MIMO precoding is set for a narrow beam.

Example 78 is the method of example 77, wherein the predefined upper threshold is different from the predefined lower threshold.

Example 79 is the method of any one of examples 63 to 78, wherein the predicted CSI value and/or the confidence metric is further based on a rate of change of a channel coefficient in a time domain.

Example 80 is the method of either one of examples 64 or 65, wherein the method further includes generating, based on the current CSI value and the learning model, a recommended periodicity of CSI measurements of the wireless channel.

Example 81 is the method of any one of examples 63 to 80, the method further including storing (e.g., via a memory) the current CSI value, the learning model, the predicted CSI value, the confidence metric, and/or the scheduling parameter.

Example 82 is a method for a user equipment, the method including measuring a current channel status information (CSI) value of a wireless channel at a current time. The method further includes generating, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. The method further includes generating a resource report for sending to a base station, wherein the resource report is based on the predicted CSI value and the confidence metric.

Example 83 is the method of example 83, wherein the resource report includes a measurement report including a reported CSI value that is either the predicted CSI value or the current CSI value, depending on whether the confidence metric satisfies a predefined criterion.

Example 84 is the method of example 83, wherein the predefined criterion includes that when the confidence level is higher than a predefined threshold, the reported CSI value is the predicted CSI value and when the confidence level is at or below the predefined threshold, the reported CSI value is the current CSI value.

Example 85 is the method of any one of examples 82 to 84, wherein the method further includes generating, based on the current CSI value and the learning model, a recommended periodicity of CSI measurements of the wireless channel.

Example 86 is the method of example 85, wherein the resource report includes a resource change request (e.g., an RRC reconfiguration request) to change a frequency of transmission of CSI reference signals (CSI-RS) to the recommended periodicity.

Example 87 is the method of any one of examples 82 to 86, wherein the resource report includes a learning model update request (e.g., an updated NN model) to transmit a revised learning model to replace the learning model, wherein the revised learning model that has been trained on a different type of mobility, on a different fading profile, or on other channel statistics.

Example 88 is a method for training a learning model that relates channel status information (CSI) values to: CSI predictions; confidence levels of the CSI predictions; and/or recommended CSI-reference signal (RS) periodicities, the method including obtaining a current CSI value that is associated with a ground truth of a predicted CSI value. The method further includes determining a predicted CSI value, a confidence level of the predicted CSI value, and/or to a recommended CSI-RS periodicity, each based on the learning model at the current CSI value. The method further includes computing a loss function that compares the predicted CSI value to the ground truth of the predicted CSI value. The method further includes updating the learning model based on the loss function.

Example 89 is the method of example 88, wherein the loss function compares the confidence level of the predicted CSI value to a ground truth of the confidence level.

Example 90 is the method of example 89, wherein the method further includes determining the ground truth of the confidence level based on a function that outputs a factor indicating the closeness of the predicted CSI value to the ground truth of the predicted CSI value.

Example 91 is the method of example 90, wherein the function is a generalized cosine similarity (GCS) function, wherein the factor is between zero and one.

Example 92 is the method of any one of examples 88 to 91, wherein the loss function compares the recommended CSI-RS periodicity to a ground truth of the recommended CSI-RS periodicity.

Example 93 is the method of example 92, wherein the method includes determining the ground truth of the recommended CSI-RS periodicity based on an optimum CSI-RS periodicity that is a function of channel coherence time, wherein the channel coherence time is based on an estimated maximum doppler frequency associated with the ground truth of the predicted CSI value.

Example 94 is an apparatus that includes a means for obtaining a current channel status information (CSI) value of a wireless channel at a current time. The apparatus also includes a means for generating, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. The apparatus also includes a means for adjusting a scheduling parameter for the wireless channel based on the predicted CSI value and the confidence metric.

Example 95 is the apparatus of example 94, wherein the apparatus further includes a means for generating, based on the current CSI value and the learning model, a recommended periodicity of CSI measurements of the wireless channel.

Example 96 is the apparatus of example 95, wherein the recommended periodicity of CSI measurements is further based on a channel coherence time for the wireless channel.

Example 97 is the apparatus of any one of examples 95 to 96, wherein the apparatus further includes a means for adjusting a frequency of transmission of CSI reference signals (CSI-RS) over the wireless channel based on the periodicity.

Example 98 is the apparatus of any one of examples 94 to 97, wherein the scheduling parameter includes a beam width for wireless transmissions over the wireless channel.

Example 99 is the apparatus of any one of examples 94 to 98, wherein when the confidence metric is high, the scheduling parameter includes a narrow beam width and when the confidence metric is low the scheduling parameter includes a wide beam width.

Example 100 is the apparatus of any one of examples 94 to 99, wherein the apparatus includes a means for generating a series of predicted CSI values, each at a corresponding prediction time that is different from (e.g., ahead of) the current time and each associated with a corresponding confidence metric, wherein the predicted CSI value and the confidence metric are one of the series of predicted CSI values and its corresponding confidence metric.

Example 101 is the apparatus of example 100, wherein when the series of predicted CSI values and their corresponding confidence metrics satisfies a predefined criterion, the apparatus further includes a means for replacing the learning model with a revised learning model that has been trained on a different type of mobility of a user equipment, on different channel characteristics, and/or on a different fading profile.

Example 102 is the apparatus of example 101, wherein the different type of mobility of the user equipment includes a different movement speed of the user equipment and/or different environmental characteristics.

Example 103 is the apparatus of example 101, wherein the different fading profile includes one of a static profile, a PB3 profile, a PA3 profile, a VA3 profile, a VA30 profile, a VA120 profile, an EPA5 profile, an EVA5 profile, an EVA70 profile, an ETU70 profile, an ETU300 profile, and an HST profile.

Example 104 is the apparatus of any one of examples 101 to 103, wherein the predefined criterion is satisfied when at least one of the corresponding confidence metrics falls below a threshold value.

Example 105 is the apparatus of any one of examples 101 to 104, wherein the predefined criterion is satisfied when a predefined number of the corresponding confidence metrics falls below a threshold value.

Example 106 is the apparatus of any one of examples 101 to 105, wherein the predefined criterion is satisfied when a predefined number of consecutive ones of the corresponding confidence metrics falls below a threshold value.

Example 107 is the apparatus of any one of examples 94 to 106, wherein the learning model further relates a movement speed of a user equipment to the CSI predictions.

Example 108 is the apparatus of any one of examples 94 to 107, wherein the scheduling parameter includes a multi-user multiple in multiple out (MU-MIMO) precoding, wherein if the confidence metric is above a predefined upper threshold, the MU-MIMO precoding is set for a narrow beam and if the confidence metric is below a predefined lower threshold, the MU-MIMO precoding is set for a narrow beam.

Example 109 is the apparatus of example 108, wherein the predefined upper threshold is different from the predefined lower threshold.

Example 110 is the apparatus of any one of examples 94 to 109, wherein the predicted CSI value and/or the confidence metric is further based on a rate of change of a channel coefficient in a time domain.

Example 111 is the apparatus of either one of examples 95 or 96, wherein the apparatus further includes a means for generating, based on the current CSI value and the learning model, a recommended periodicity of CSI measurements of the wireless channel.

Example 112 is the apparatus of any one of examples 94 to 111, the apparatus further including a means for storing (e.g., a memory) the current CSI value, the learning model, the predicted CSI value, the confidence metric, and/or the scheduling parameter.

Example 113 is an apparatus for a user equipment, the apparatus including a means for measuring a current channel status information (CSI) value of a wireless channel at a current time. The apparatus further includes a means for generating, based on the current CSI value and a learning model that is based on (e.g., relates) CSI values and CSI predictions: a predicted CSI value for the wireless channel at a prediction time that is different from (e.g., ahead of) the current time; and a confidence metric for the predicted CSI value based on the learning model, wherein the confidence metric indicates a level of confidence in the predicted CSI value for the prediction time. The apparatus further includes a means for generating a resource report for sending to a base station, wherein the resource report is based on the predicted CSI value and the confidence metric.

Example 114 is the apparatus of example 114, wherein the resource report includes a measurement report including a reported CSI value that is either the predicted CSI value or the current CSI value, depending on whether the confidence metric satisfies a predefined criterion.

Example 115 is the apparatus of example 114, wherein the predefined criterion includes that when the confidence level is higher than a predefined threshold, the reported CSI value is the predicted CSI value and when the confidence level is at or below the predefined threshold, the reported CSI value is the current CSI value.

Example 116 is the apparatus of any one of examples 113 to 115, wherein the apparatus further includes a means for generating, based on the current CSI value and the learning model, a recommended periodicity of CSI measurements of the wireless channel.

Example 117 is the apparatus of example 116, wherein the resource report includes a resource change request (e.g., an RRC reconfiguration request) to change a frequency of transmission of CSI reference signals (CSI-RS) to the recommended periodicity.

Example 118 is the apparatus of any one of examples 113 to 117, wherein the resource report includes a learning model update request (e.g., an updated NN model) to transmit a revised learning model to replace the learning model, wherein the revised learning model that has been trained on a different type of mobility, on a different fading profile, or on other channel statistics.

Example 119 is a apparatus for training a learning model that relates channel status information (CSI) values to: CSI predictions; confidence levels of the CSI predictions; and/or recommended CSI-reference signal (RS) periodicities, the apparatus including obtaining a current CSI value that is associated with a ground truth of a predicted CSI value. The apparatus further includes a means for determining a predicted CSI value, a confidence level of the predicted CSI value, and/or to a recommended CSI-RS periodicity, each based on the learning model at the current CSI value. The apparatus further includes a means for computing a loss function that compares the predicted CSI value to the ground truth of the predicted CSI value. The apparatus further includes a means for updating the learning model based on the loss function.

Example 120 is the apparatus of example 119, wherein the loss function includes a means for comparing the confidence level of the predicted CSI value to a ground truth of the confidence level.

Example 121 is the apparatus of example 120, wherein the apparatus further includes a means for determining the ground truth of the confidence level based on a function that outputs a factor indicating the closeness of the predicted CSI value to the ground truth of the predicted CSI value.

Example 122 is the apparatus of example 121, wherein the function is a generalized cosine similarity (GCS) function, wherein the factor is between zero and one.

Example 123 is the apparatus of any one of examples 119 to 122, wherein the loss function includes a means for comparing the recommended CSI-RS periodicity to a ground truth of the recommended CSI-RS periodicity.

Example 124 is the apparatus of example 123, wherein the apparatus includes a means for determining the ground truth of the recommended CSI-RS periodicity based on an optimum CSI-RS periodicity that is a function of channel coherence time, wherein the channel coherence time is based on an estimated maximum doppler frequency associated with the ground truth of the predicted CSI value.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising a processor configured to:
obtain a current channel status information (CSI) value of a wireless channel at a current time; and
generate, based on the current CSI value and a learning model that is based on CSI values and CSI predictions:
a predicted CSI value for the wireless channel at a prediction time that is different from the current time; and
a confidence metric for the predicted CSI value based on the learning model, wherein the confidence metric indicates a level of confidence in the predicted CSI value for the prediction time; and
adjust a scheduling parameter for the wireless channel based on the predicted CSI value and the confidence metric.

2. The device of claim 1, wherein the processor is further configured to generate, based on the current CSI value and the learning model, a recommended periodicity of CSI measurements of the wireless channel.

3. The device of claim 2, wherein the processor is further configured to adjust a frequency of transmission of CSI reference signals (CSI-RS) over the wireless channel based on the periodicity.

4. The device of claim 1, wherein the scheduling parameter comprises a beam width for wireless transmissions over the wireless channel.

5. The device of claim 1, wherein when the confidence metric is high, the scheduling parameter comprises a narrow beam width and when the confidence metric is low the scheduling parameter comprises a wide beam width.

6. The device of claim 1, wherein when predicted CSI value and the corresponding confidence metric satisfies a predefined criterion, the processor is further configured to replace the learning model with a revised learning model that has been trained on a different type of mobility of a user equipment, on different channel characteristics, and/or on a different fading profile.

7. The device of claim 6, wherein the different type of mobility of the user equipment comprises a different movement speed of the user equipment and/or different environmental characteristics.

8. The device of claim 6, wherein the different fading profile comprises one of a static profile, a PB3 profile, a PA3 profile, a VA3 profile, a VA30 profile, a VA120 profile, an EPA5 profile, an EVA5 profile, an EVA70 profile, an ETU70 profile, an ETU300 profile, and an HST profile.

9. The device of claim 1, wherein the learning model further relates a movement speed of a user equipment to the CSI predictions.

10. The device of claim 1, wherein the scheduling parameter comprises a multi-user multiple in multiple out (MU-MIMO) precoding, wherein if the confidence metric is above a predefined upper threshold, the MU-MIMO precoding is set for a narrow beam and if the confidence metric is below a predefined lower threshold, the MU-MIMO precoding is set for a narrow beam.

11. The device of claim 10, wherein the predefined upper threshold is different from the predefined lower threshold.

12. The device of claim 1, wherein the predicted CSI value and/or the confidence metric is further based on a rate of change of a channel coefficient in a time domain.

13. A user equipment comprising a processor configured to:
measure a current channel status information (CSI) value of a wireless channel at a current time; and
generate, based on the current CSI value and a learning model that is based on CSI values and CSI predictions:
a predicted CSI value for the wireless channel at a prediction time that is different from the current time; and
a confidence metric for the predicted CSI value based on the learning model, wherein the confidence metric indicates a level of confidence in the predicted CSI value for the prediction time; and
generate a resource report for sending to a base station, wherein the resource report is based on the predicted CSI value and the confidence metric.

14. The device of claim 13, wherein the resource report comprises a measurement report comprising a reported CSI value that is either the predicted CSI value or the current CSI value, depending on whether the confidence metric satisfies a predefined criterion.

15. The device of claim 14, wherein the predefined criterion comprises that when the confidence level is higher than a predefined threshold, the reported CSI value is the predicted CSI value and when the confidence level is at or below the predefined threshold, the reported CSI value is the current CSI value.

16. The device of claim 13, wherein the processor is further configured to generate, based on the current CSI value and the learning model, a recommended periodicity of CSI measurements of the wireless channel.

17. The device of claim 16, wherein the resource report comprises a resource change request (e.g., an RRC reconfiguration request) to change a frequency of transmission of CSI reference signals (CSI-RS) to the recommended periodicity.

18. The device of claim 13, wherein the resource report comprises a learning model update request (e.g., an updated NN model) to transmit a revised learning model to replace the learning model, wherein the revised learning model that has been trained on a different type of mobility, on a different fading profile, or on other channel statistics.

19. A non-transitory computer-readable medium for training a learning model that relates channel status information (CSI) values to: CSI predictions; confidence levels of the CSI predictions; and/or recommended CSI-reference signal (RS) periodicities, the non-transitory computer-readable medium comprising instructions that, when executed, cause one or more processors to:
obtain a current CSI value that is associated with a ground truth of a predicted CSI value;
determine a predicted CSI value, a confidence level of the predicted CSI value, and/or to a recommended CSI-RS periodicity, each based on the learning model at the current CSI value;
compute a loss function that compares the predicted CSI value to the ground truth of the predicted CSI value; and
update the learning model based on the loss function.

20. The non-transitory computer-readable medium of claim 19, wherein the loss function also compares the confidence level of the predicted CSI value to a ground truth of the confidence level, wherein the ground truth of the confidence level is based on a function that outputs a factor indicating the closeness of the predicted CSI value to the ground truth of the predicted CSI value.
